(19) United States
(12) Patent Application Publication
(10) Pub. No.: US 2023/0145781 A1
(43) Pub. Date: May 11, 2023

(54) TELECOMMUNICATIONS REMOTE TERMINAL FIELD DEVICE MONITORING USING DISTRIBUTED FIBER OPTIC SENSING

(71) Applicant: NEC Laboratories America, Inc., Princeton, NJ (US)

(72) Inventors: Yangmin DING, East Brunswick, NJ (US); Sarper OZHARAR, Pennington, NJ (US); Yue TIAN, Princeton, NJ (US); Ting WANG, West Windsor, NJ (US)

(73) Assignee: NEC LABORATORIES AMERICA, INC, Princeton, NJ (US)

(21) Appl. No.: 17/978,845

(22) Filed: Nov. 1, 2022

Related U.S. Application Data
(60) Provisional application No. 63/276,038, filed on Nov. 5, 2021.

(51) Int. Cl. G01H 9/00; H04B 10/80; H04B 10/2537

(52) U.S. Cl. CPC G01H 9/004; H04B 10/808; H04B 10/2537

(57) ABSTRACT

Remote terminal field device monitoring using distributed fiber optic sensing (DFOS) comprising a length of optical sensor fiber extending into the remote terminal, said remote terminal including one or more field devices located therein, wherein said length of optical sensor fiber located in the remote terminal includes one or more fiber loops formed in the length of optical sensor fiber, said one or more fiber loops respectively positioned proximate to the one or more field device(s) located in the remote terminal, a DFOS interrogator in optical communication with the optical sensor fiber and configured to generate optical pulses, introduce the generated pulses into the length of optical sensor fiber, and receive backscattered signals from the one or more fiber loops formed in the length of the optical sensor fiber, and an intelligent analyzer configured to analyze DFOS data received by the DFOS interrogator and determine from the backscattered signals, environmental activity occurring at the one or more fiber loops located within the remote terminal; operating the DFOS system and collecting/analyzing/reporting the environmental activity determined at the one or more fiber loops located within the remote terminal.

### CROSS REFERENCE

This application claims the benefit of U.S. Provisional Patent Application Ser. No. 63/276,038 filed 5 Nov. 2021, the entire contents of which being incorporated by reference as if set forth at length herein.

### TECHNICAL FIELD

This disclosure relates generally to distributed fiber optic sensing (DFOS) systems, methods, and structures. More particularly, it discloses telecommunications remote terminal field device monitoring using distributed fiber optic sensing.

### BACKGROUND

As those skilled in the art will understand and appreciate, remote terminals play an important role in telecommunications networks as they host valuable field devices and equipment that monitor network digital and analog parameters and report data for subsequent management and control of the networks. Given such importance, system, methods, and structures that enhance and/or facilitate the monitoring of these remote terminals would represent a welcome addition to the art.

### SUMMARY

An advance in the art is made according to aspects of the present disclosure directed to telecommunications remote terminal field device monitoring using distributed fiber optic sensing.

In sharp contrast to the prior art, aspects of the present disclosure describe a method for remote terminal field device monitoring using distributed fiber optic sensing (DFOS) comprising: providing the DFOS system including a length of optical sensor fiber extending into the remote terminal, said remote terminal including one or more field devices located therein, wherein said length of optical sensor fiber located in the remote terminal includes one or more fiber loops formed in the length of optical sensor fiber, said one or more fiber loops respectively positioned proximate to the one or more field device(s) located in the remote terminal; a DFOS interrogator in optical communication with the optical sensor fiber, said DFOS interrogator configured to generate optical pulses, introduce the generated pulses into the length of optical sensor fiber, and receive backscattered signals from the one or more fiber loops formed in the length of the optical sensor fiber and located in the remote terminal; and an intelligent analyzer configured to analyze DFOS data received by the DFOS interrogator and determine from the backscattered signals, environmental activity occurring at the one or more fiber loops located within the remote terminal; and operating the DFOS system and collecting/analyzing/reporting the environmental activity determined at the one or more fiber loops located within the remote terminal.

### BRIEF DESCRIPTION OF THE DRAWING

A more complete understanding of the present disclosure may be realized by reference to the accompanying drawing in which:

FIG. 1 is a schematic diagram illustrating a DFOS system as is known in the art;

FIG. 2 is a schematic diagram of an illustrative telecommunications remote terminal floor plan according to aspects of the present disclosure;

FIG. 3 is a schematic diagram of an illustrative telecommunications remote terminal floor plan and operational flow according to aspects of the present disclosure; and

FIG. 4 is schematic diagram showing illustrative use cases and corresponding algorithms for condition monitoring according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we begin by noting that distributed fiber optic sensing (DFOS) is an important and widely used technology to detect environmental conditions (such as temperature, vibration, acoustic excitation vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. DFOS can also employ a signal of forward direction that uses speed differences of multiple modes. Without losing generality, the following description assumes reflected signal though the same approaches can be applied to forwarded signal as well.

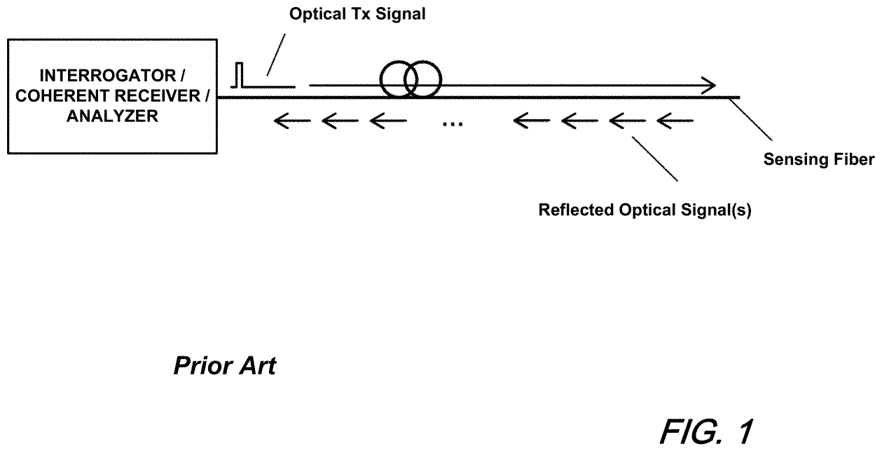

FIG. 1 is a schematic diagram of a generalized, prior-art DFOS system. As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example —a mechanical vibration. As will be understood and appreciated, the interrogator may include a coded DFOS system that may employ a coherent receiver arrangement known in the art.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate that by implementing a signal coding on the interrogation signal enables the sending of more optical power into the fiber which can advantageously improve signal-to-noise ratio (SNR) of Rayleigh-scattering based system (e.g. distributed acoustic sensing (DAS), distributed vibration sensing (DVS)) and Brillouin-scattering based system (e.g. Brillouin optical time domain reflectometry or BOTDR).

As currently implemented in many contemporary implementations, dedicated fibers are assigned to DFOS systems in fiber-optic cables—physically separated from existing optical communication signals which are conveyed in different fiber(s). However, given the explosively growing bandwidth demands, it is becoming much more difficult to economically operate and maintain optical fibers for DFOS operations only. Consequently, there exists an increasing interest to integrate communications systems and sensing systems on a common fiber that may be part of a larger, multi-fiber cable.

Operationally, we assume that the DFOS system will be Rayleigh-scattering based system (e.g., distributed acoustic sensing or DAS, distributed vibration sensing, DVS) and Brillouin-scattering based system (e.g., Brillouin optical time domain reflectometry or BOTDR) with a coding implementation. With such coding designs, these systems will be most likely be integrated with fiber communication systems due to their lower power operation and will also be more affected by the optical amplifier response time.

As those skilled in the art will understand and appreciate, remote terminal plays an important role in telecommunication services as it hosts valuable field devices/equipment and monitors the filed digital and analog parameters, as well as transmits data to a supervisory control and data acquisition (SCADA) master station where events are presented for effective management and control decisions. Those skilled in the art will recognize that SCADA is a control system architecture that includes computers, networked data communications and graphical user interface systems for high-level supervision of machines and processes

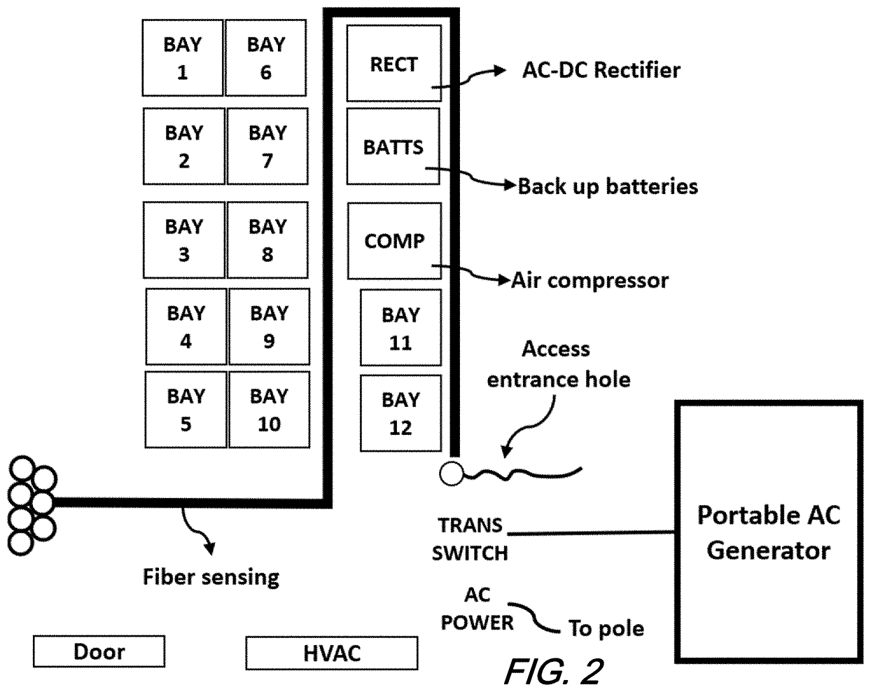

FIG. 2 is a schematic diagram of an illustrative telecommunications remote terminal floor plan according to aspects of the present disclosure. As schematically illustrated in that figure, a remote terminal includes a number of equipment bays that may contain telecommunications equipment along with electrical backup batteries and heating, ventilation, and air conditioning equipment. Shown further is a fiber sensing arrangement is one focus of the present disclosure.

With continued reference to that figure, we note that much telecommunications equipment located in the remote terminal is connected to twisted pairs of copper wire which operate at −48 v DC with a filtered ground to avoid interference on fine gauge twisted pairs. An AC-DC rectifier converts the alternating current (AC) into a single-directional direct current (DC) when operated from a station battery system. Backup battery and charger circuitry provide continuous operation for emergency use in event of AC power failure. An air compressor keeps positive air pressure in the air core copper cables since positive air pressure keeps the copper wire and cable dry.

Another important feature of the remote terminal as schematically illustrated is an access entrance hole which provides the entry to a portable AC generator. In the case of AC (commercial) power failure, the telecommunications service provider must be notified immediately of the outage time, duration, and location. Otherwise, the request for an AC generator cannot be delivered promptly. If the outage is not corrected timely, communication services will be interrupted.

To maintain efficiency and communicate system issues that mitigate downtime, a remote terminal is equipped with the SCADA systems. For example, a SCADA system can notify an operator that a channel is showing an error. The operator then pauses the operation and views SCADA system data to determine causes of the issue. However, a SCADA system is complex in terms of hardware units and dependent modules and often requires skilled operators to maintain. Furthermore, if not equipped with designated sensors, a SCADA is unable to monitor the operating status of a rectifier or an air compressor. The SCADA system requires an external power supply as well, thus when a backup battery runs out of power, the SCADA system will be disconnected.

As we shall show and describe, systems, methods, and structures according to aspects of the present disclosure advantageously monitor an operating status of the remote terminal, including the conditions of any field devices located in the remote terminal and AC power status—all using DFOS—which may advantageously eliminate any need to poll SCADA data on the monitoring devices for telecommunications operation status/properties.

By using DFOS interrogative techniques, systems, methods and structures according to aspects of the present disclosure obtain real-time responses of field devices located in a remote terminal where fiber optic cable is deployed. These physical disturbances include but are not limited to temperature, vibration, and acoustics. The change in physical quantities by interrogating the backscattering of an optical pulse traveling along the fiber cable can be measured. Using this technology, the existing kilometer-long communication purpose optical fiber can act as thousands of individual sensors without requiring additional sensors, external power, and communication channels for data transfer.

Furthermore, the observation of the operating status of all the field devices where fiber cable is connected in the remote terminal can be done from one end of the fiber with extreme precision and sensitivity. If the same cable route crosses multiple remote terminals, this technology can be expanded to monitor all the terminals along the fiber cable route, which drastically reduces the operation and maintenance costs, improves monitoring efficiency, and lowers project risk.

Of particular advantage, existing, previously deployed, optical fiber cable—when used for remote terminal sensing and communication—provides real-time monitoring of physical disturbances of field devices, with high sensitivity and exhibits an ultra-long sensing range without additional sensors and implications. This means there is no need to establish new sensing and communication networks. Thus, the entire process of acquiring data through SCADA networks is no longer necessary.

Another feature according to our disclosure involves how operating conditions of the field devices are monitored and diagnosed. According to aspects of the present disclosure, our inventive systems and methods employ fiber coils as sensing points to measure vibrations and temperatures of the field device that result from physical (temperature/acoustic/vibration) disturbances. For example, to monitor the operating condition of an air compressor, we a fiber coil is placed on the air compressor and, in this manner, a DFOS signal strength is improved, and the location of the air compressor can be more readily identified. Advantageously, such fiber coils are easy to obtain and mount. For the diagnosis of the operating conditions of the field devices, we perform time domain and frequency domain analysis and develop machine learning models for anomaly classification.

Operationally, our inventive systems and methods may generally operate according to the following procedural outline.

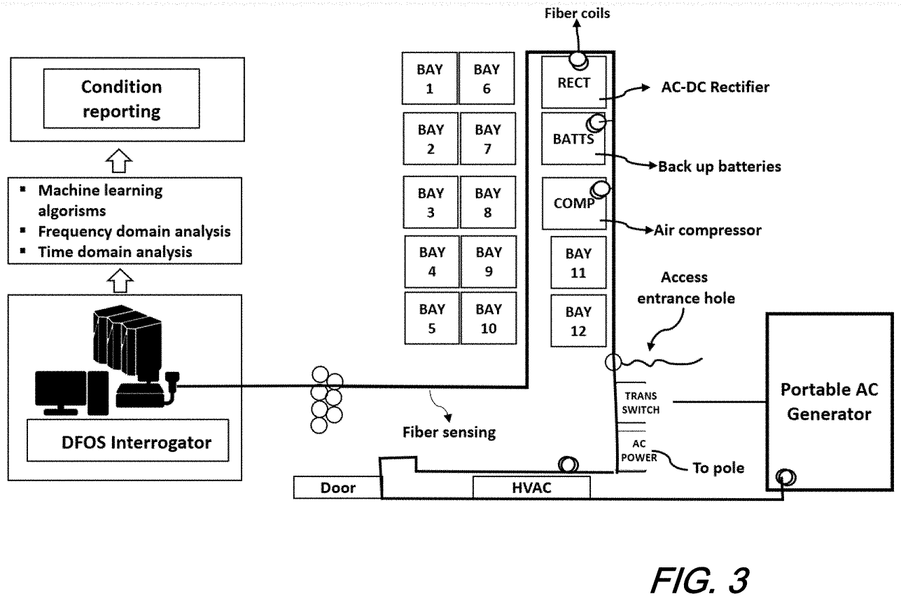

FIG. 3 is a schematic diagram of an illustrative telecommunications remote terminal floor plan and operational flow according to aspects of the present disclosure.

Determine Locations and Length of Fiber Coils

Based on the monitoring scenarios and user input spatial resolution, the fiber coil location(s) and length(s) is determined. For example, to monitor the air compressor operating status, the fiber coils can be placed on the top of the compressor and the length of the fiber coil should at least cover the spatial resolution.

Data Collection

Next, the DAS interrogator is connected to the cable route for field device monitoring. The real-time vibration data collected is processed in the pre-processing unit where filtering, normalization, and threshold processing are employed to denoise the raw signal.

Data Analysis

The preprocessed data collected from DFOS operation is analyzed by different algorithms for condition monitoring. For some use cases, the basic frequency domain analysis such as fast Fourier transform (FFT) is good enough to detect the abnormal operating status. For other application scenarios, such as the status of an air compressor, more advanced algorithms such as machine learning classification can be applied.

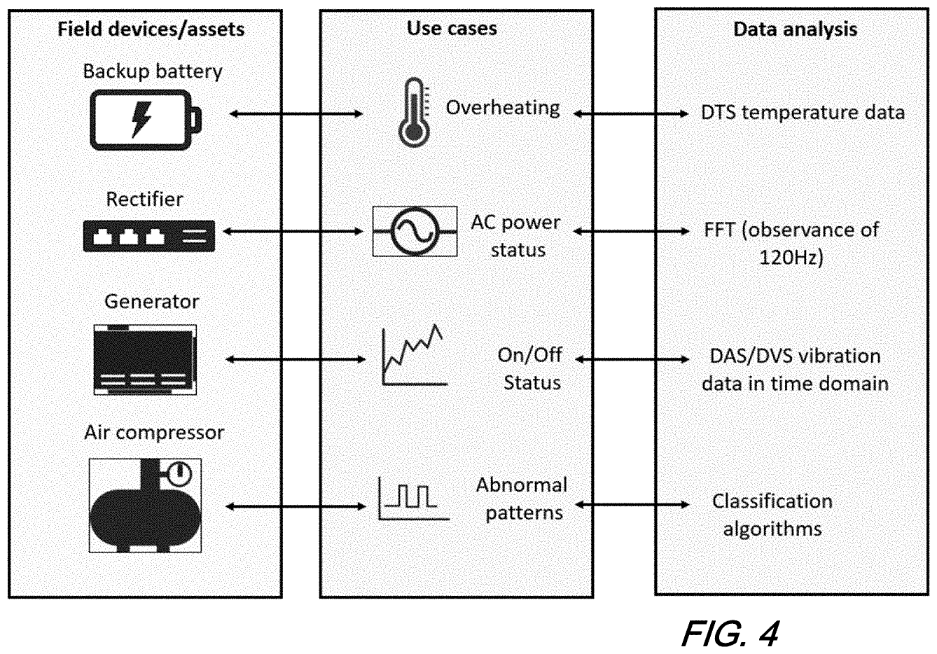

FIG. 4 is schematic diagram showing illustrative use cases and corresponding algorithms for condition monitoring according to aspects of the present disclosure. As shown in that figure, there are a number of field devices/assets that may be monitored and the subject of use cases including the backup battery—overheating—DTS temperature; the rectifier—AC power status—FFT analysis of 120 HZ; the generator—On/Off Status—DAS/DVS vibration data in time domain; and the air compressor—abnormal vibration patterns—classification algorithms. Accordingly, the following illustrative use cases may proceed as follows.

### Use Case Examples

AC Power Status Monitoring

Since the rectifier converts AC into DC, so the normal AC status can be monitored by detecting the AC components (120 Hz and its harmonics) from distributed fiber sensing coil on the rectifier.

As those skilled in the art will appreciate, when the AC power is on, the AC component of 120 Hz can be detected by fiber sensing from the rectifier using FFT since the rectifier runs on AC power, whereas when an outage occurs, the 120 Hz disappears. When a generator is connected, or the power is established again, the 120 Hz is detected.

By detecting when the 120 Hz disappears, we can identify the time of the outage and the telecom carrier can immediately send a request for a generator.

When the generator is sent to the field and turned on, the fiber coils on the generator can detect the vibration which tells the generator is working.

When the outage occurs, the backup batteries kick in and the air compressor stops running to save the battery otherwise the battery capacity would exhaust very quickly. By monitoring the vibration signal of the air compressor, we can tell if the battery is running or the generator is running

Generator Status Monitoring

Generator status can be monitored by detecting the vibration pattern in the time domain/frequency domain from the fiber coil on the generator. As may be appreciated, the time domain vibration data shows a strong amplitude, and the energy is evenly distributed, whereas the frequency domain results show the low-frequency components dominants while a generator is working properly.

At this point, while we have presented this disclosure using some specific examples, those skilled in the art will recognize that our teachings are not so limited. Accordingly, this disclosure should only be limited by the scope of the claims attached hereto.

1. A method for remote terminal field device monitoring using distributed fiber optic sensing (DFOS) comprising:
providing the DFOS system including
a length of optical sensor fiber extending into the remote terminal, said remote terminal including one or more field devices located therein, wherein said length of optical sensor fiber located in the remote terminal includes one or more fiber loops formed in the length of optical sensor fiber, said one or more fiber loops respectively positioned proximate to the one or more field device(s) located in the remote terminal;
a DFOS interrogator in optical communication with the optical sensor fiber, said DFOS interrogator configured to generate optical pulses, introduce the generated pulses into the length of optical sensor fiber, and receive backscattered signals from the one or more fiber loops formed in the length of the optical sensor fiber and located in the remote terminal; and
an intelligent analyzer configured to analyze DFOS data received by the DFOS interrogator and determine from the backscattered signals, environmental activity occurring at the one or more fiber loops located within the remote terminal;
operating the DFOS system and collecting/analyzing/reporting the environmental activity determined at the one or more fiber loops located within the remote terminal.

2. The method of claim 1 wherein the environmental activity determined includes DFOS temperature data (DFOS/DTS) associated with a backup battery overheating condition from a fiber loop positioned proximate to the backup battery located within the remote terminal.

3. The method of claim 1 wherein the environmental activity determined includes alternating current (AC) power status associated with a rectifier power conditioner detected at a fiber loop positioned proximate to the rectifier located in the remote terminal.

4. The method of claim 3 wherein the environmental activity is determined from AC power status by detecting AC components including 120 Hz components and harmonics via DFOS distributed vibration sensing (DFOS/DVS).

5. The method of claim 4 wherein the 120 Hz components are determined using a fast fourier transform (FFT).

6. The method of claim 1 wherein the environmental activity determined includes on/off status of an electrical generator using DFOS distributed acoustic sensing (DFOS/DAS) data detected at a fiber loop positioned proximate to the electrical generator.

7. The method of claim 1 wherein the environmental activity determined includes on/off status of an electrical generator using DFOS distributed vibration sensing (DFOS/DVS) data detected at a fiber loop positioned proximate to the electrical generator.

8. The method of claim 1 wherein the environmental activity determined includes abnormal patterns of operation of an air compressor positioned within the remote terminal, the abnormal patterns determined using DFOS/DVS data detected at a fiber loop positioned proximate to the air compressor and analyzed by an intelligent analyzer using a classification algorithm.
